(19) United States
(12) Patent Application Publication
(10) Pub. No.: US 2023/0058422 A1
(43) Pub. Date: Feb. 23, 2023

(54) CUTTING BLADE

(71) Applicant: Tritana Intellectual Property Ltd., Saskatoon (CA)

(72) Inventor: Dean Mayerle, Saskatoon (CA)

(21) Appl. No.: 17/888,866

(22) Filed: Aug. 16, 2022

Related U.S. Application Data
(60) Provisional application No. 63/235,422, filed on Aug. 20, 2021.

(51) Int. Cl. B23K 26/244; B23K 26/361

(52) U.S. Cl. CPC B23K 26/244; B23K 26/361; A01D 34/73

(57) ABSTRACT

A cutting blade for vegetation is provided for example for use in a straw chopper or rotary mower. The blade body includes a first base material and at least one hard surface bead formed on at least one surface of the base material extending up to a cutting edge of the base material. Beads can be applied longitudinally by the heat energy from the cladding laser system to form pockets so that the blade is serrated by the pockets when supplied with additional wear increasing the pockets to maintain the serrations. The chamfered side face of the blade body forming the cutting edge can also be formed using heat energy from the same laser cutting and cladding system.

This application claims the benefit under 35 USC 119 (e) of Provisional application 63/235,422 filed Aug. 20, 2021.

This invention relates to a cutting blade for vegetation for example for use in an apparatus for chopping and discharging straw from a combine harvester, in a rotary mower or other arrangement in which a free blade is rotated to cut into crop material.

### BACKGROUND OF THE INVENTION

Reference is made to US Published Application US2018/0281760 published Sep. 19, 2019 which discloses a cutting blade for vegetation for example for use in a straw chopper or rotary mower. The blade includes a first base material and a plurality of hard surface beads of at least two different materials formed on one surface of the base material extending up to a cutting edge of the base material where the beads lie alternately side by side with touching side edges and one contains at least one different material of a different hardness relative to the other so that differential wear rates are created, and a wear profile is controlled. The softer material is burnt away at the edge by the cladding laser to form pockets so that the blade is serrated by the pockets when supplied with additional wear increasing the pockets to maintain the serrations.

The present application provides improvements and modifications based on the above disclosure which may provide an improved cutting effect and/or an improved economy of manufacture. The disclosure of the above application may be referenced for further detail or is incorporated herein by reference.

### SUMMARY OF THE INVENTION

According to a first aspect of the invention there is provided a method for forming a blade for mounting on a rotor of a cutting machine for cutting vegetation comprising:

forming a chamfered surface on a blade body to define a cutting edge of the blade body;

the blade body being formed of a base material;

applying at least one strip of cladding material to the blade body at the cutting edge so as to provide at least one part of the cutting edge which has the cladding material thereon;

the cladding material having a resistance to wear greater than that of the base material;

said at least one strip being applied in a direction longitudinal of the cutting edge so that said at least one strip has a length extending along the cutting edge and a width extending from a first side edge of said at least one strip at the cutting edge and a second side edge spaced from said cutting edge;

and applying heat energy to the cutting edge at a plurality of spaced locations along the cutting edge so as to remove away portions of the cutting edge to form a series of recessed pockets along the cutting edge at the locations.

According to a further aspect of the invention there is provided a method for forming a blade for mounting on a rotor of a cutting machine for cutting vegetation comprising:

forming a chamfered surface on a blade body to define a cutting edge of the blade body;

the blade body being formed of a base material;

applying at least one strip of cladding material to the blade body at the cutting edge so as to provide at least one part of the cutting edge which has the cladding material thereon;

the cladding material having a resistance to wear greater than that of the base material;

wherein said at least one strip comprises two strips with one arranged on the chamfered surface and one arranged on an opposed surface; and

applying heat energy to the cutting edge at a plurality of spaced locations along the cutting edge so as to remove away portions of the cutting edge to form a series of recessed pockets along the cutting edge at the locations.

In accordance with an important feature of the invention which can be used independently, the chamfered surface at the edge of the blade body can optionally also be cut using heat energy.

In this arrangement, preferably the blade body is mounted in a laser heating system and the laser heating system is used both to cut the chamfered surface and to apply the cladding material. Also it can be used to cut the series of recessed pockets and to apply the cladding material. Thus using one system a blank metal bar forming the blade body can be cut, coated and serrated in one process using a common laser heating system. However one or more of the steps may be carried out independently using another heat application system.

Where a common laser system is used, the laser system may provide one work cell with two laser heads with different focal optics. Alternatively the laser system may comprise one laser head with adjustable optics.

In one arrangement, the strip or strips are applied before the series of recessed pockets are cut so that the heat energy to cut the series of recessed pockets also cuts through the strip.

In another arrangement, the strip or strips are applied after the series of recessed pockets are cut so that the cladding material, typically a powder is discarded at the series of recessed pockets as there is no material at those locations on to which the material is applied.

The strip can comprise a single strip applied to one surface and typically to the flat surface opposite the chamfered surface, which forms a planar side of the blade body. Alternatively, two strips can be applied with one arranged on the chamfered surface and one arranged on the opposed surface. These strips thus meet at the edge and provide a highly wear resistant or hardened edge. However the hardened edge can still be cut away at the required locations to form the serrations. The chamfered surface is flat.

Typically the cladding material has a thickness in the range 0.005 to 0.030 inches. However different thicknesses can be used.

Preferably the material is laser clad so that the material comprises a bead of powder which is fused to the base material by laser heating. However other cladding methods can be used.

The blades are typically used in a chopper and discharge apparatus arranged to be mounted at the rear discharge of a combine harvester for receiving the straw and/or chaff from the combine harvester and for discharging the materials from the combine harvester, the apparatus comprising:

a housing having a feed opening into which straw and/or chaff can be fed from the combine harvester and a discharge opening through which the chopped materials are discharged;

a chopping assembly mounted in the housing and comprising a hub member mounted for rotation about a longitudinal axis of the hub member and a plurality of blade members mounted on the hub member for rotation therewith about said axis for chopping the fed materials and accelerating the chopped materials for discharge. However other uses are possible such as in a rotary mower.

In the chopper, preferably the chopping assembly comprises a center chopping section and two end fan sections, the blade members in the center chopping section and the two end fan sections being arranged such that an air flow generated thereby is driven radially outwardly by the blade members so as to exit from the housing radially outwardly from the blade members through the discharge opening, the blade members in the center chopping section being substantially all cutting blade members, the blade members in each of the fan sections being substantially all fan blade members each of which includes a fan blade portion arranged to extend outwardly to at least one axial side of the radial plane so as to generate an increased air flow relative to said cutting blade members.

Preferably the chopping blades are formed from a single flat sheet of metal defining the plate where the front and rear edges of the plate are both sharpened to allow reversal when the first edge is worn.

However in some cases the fan blades blade each have a transverse portion bent out of a plane of the plate where only a front edge of the plate is sharpened for use as a fan cutting blade.

It is also possible to use the method herein to form both hard clad surfaces and a serrated edge in a single action without the necessity to carry out grinding of serrations into the hardened base material.

That is, when applying the coating the energy generated by the laser in the cladding application acts to create the start to a serration on a straight edged blade. This can be done by controlling certain parameters such as the power, laser focal point and speed of movement of the laser cladding machine. There is a significant amount of power and heat created when applying a clad bead. Both the blade and clad material are melted by the laser during the application and are bonded at a molecular level. In this way, as the edge of the blade is approached using the laser cladding system, if the power is on a high setting, or continues with a high power setting, as the parent material is thinning out as the heat approaches the beveled or chamfered edge, the laser acts to burn through and thus create a pocket or scallop at the edge which acts as a start to the serration.

That is creation of a serrated edge can be obtained by burning off the edge of the parent material when applying the clad material. This can also be achieved as separate steps of the same setup where the laser cladding machine can cut the edge then coat if necessary. In this way the area between the strips can be defined by the base material or by a second less hard cladding material.

That is the term “greater hardness” used herein is in effect synonymous with “greater average hardness”. Thus the distinguishing feature of the material can be determined by detecting an actual wear rate or by determining he greater average hardness of the material or by determining the number of hard particles in the matrix. In some embodiments the locations between each strip and the next are defined by the base material itself without application of any second bead. In this case the application of the laser energy is carried out to cut the serrated pocket in a similar procedure but without application of any cladding material.

It is particularly important herein that the chamfered edge is flat so as to be free from ground serrations. This avoids the necessity to carry out a grinding action and then to apply a coating after the grinding is completed.

Where the blade member has one flat surface and one chamfered surface converging toward the flat surface at the cutting edge preferably the cladding material or materials are applied on the flat surface. However they can be applied instead on the opposed chamfered surface.

The term material hardness or average hardness is used herein to reference the hardness or resistance to wear of the material, bearing in mind that the material is not typically homogeneous but may have a matrix containing hard particles so that the hardness is determined by the number or type of the hardening particles. For hardness therefore the method acts really to control average hardness of the coating. The carbide particles will have a certain hardness and matrix will have a hardness lower than the carbide. Therefore when the matrix contains 60% carbide vs 40% carbide the average hardness is higher but at a micro hardness level if measured would measure either a carbide particle or the matrix particles and they would measure the same whether it is in the 60% or 40% mix. It is the average of a number of measurements to determine the “hardness” of the coating.

Currently the optics in the cladding system are most efficiently selected to create a 15 mm wide coating with the laser running longitudinal to the blade edge. That is there is a single pass of a 15 mm wide coating strip. This compares to the optics being set at 0.1 mm for cutting. This difference in focal points is why there are typically two different heads for a machine that is capable of doing both operations. Typically the operator would have to stop and replace the head to match the desired operation. High volume shops typically set up their robots as either a cutting robot or a cladding robot. However it is quite possible to envision one cell with two robots if it is economically justified.

In a further possible process, a stamped blank is laser coated on the flat surface then the bevel (or chamfer) and serrations are cut in one pass with a robotic holder holding the blade at the correct angle and then pivoting the angle at the pocket location to create the serration pockets.

### BRIEF DESCRIPTION OF THE DRAWINGS

One embodiment of the invention will now be described in conjunction with the accompanying drawings in which:

FIG. 1 is an isometric view of an edge portion of a first embodiment of self-sharpening, self-serrating cutting blade according to the invention for use in for example a straw chopper.

FIG. 2 is a cross-sectional view along the line 2 of FIG. 1.

FIG. 3 is a cross-sectional view along the line 3 of FIG. 1.

FIG. 4 is an isometric view of an edge portion of a second embodiment of self-sharpening, self-serrating cutting blade according to the invention similar to that of FIG. 1 but including two strips of cladding material with one on each side.

FIG. 5 is a schematic illustration of a first step in a method according to the invention of manufacturing of the embodiments of FIGS. 1 and 4.

FIG. 6 is a schematic illustration of a second step in a method according to the invention of manufacturing of the embodiments of FIGS. 1 and 4.

FIG. 7 is a schematic illustration of a third step in a method according to the invention of manufacturing of the embodiments of FIGS. 1 and 4.

FIG. 8 is a schematic illustration of an alternative method according to the invention of manufacturing of the embodiments of FIGS. 1 and 4 where the pockets are formed in a first step before the cladding material is applied.

FIGS. 9 and 10 show a schematic illustration of a further alternative method according to the invention of manufacturing of the embodiments of FIGS. 1 and 4 where the cladding material is applied first and subsequently in a single step the chamfered edge is cut and the pockets are applied.

In the drawings like characters of reference indicate corresponding parts in the different figures.

### DETAILED DESCRIPTION

The blade herein can be used for example in the straw chopper construction of the general type shown in the prior patents of Redekop Manufacturing which are U.S. Pat. Nos. 6,840,854; 5,232,405 and 5,482,508, the disclosures of which are incorporated herein by reference.

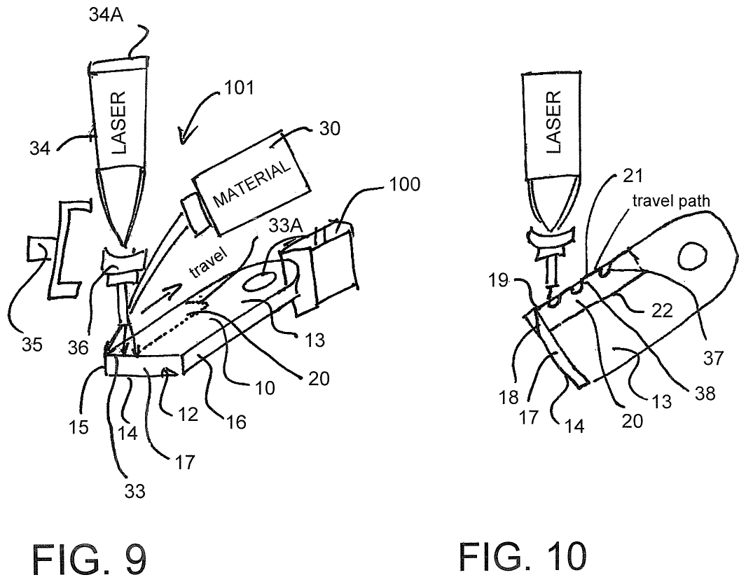

The blade shown in FIGS. 9 and 10 includes a plate 10 having a mounting hole 11 through the plate for mounting on a bushing carried on a pin of a rotor (not shown). While one mounting hole is shown allowing the blade to act as a flail pivotal around the axis of the mounting hole, other mounting arrangements can be provided.

The blade 10 comprises a generally flat elongate blade of a base material 12 having a top surface 13, a bottom surface 14, two side edges 15, 16 and an end edge 17. The blade is typically stamped from uncoiled strip steel rolls but other manufacturing arrangements can be used.

At least one side edge 15 or 16, and typically both side edges, is chamfered at edge 18 to form a cutting edge 19 on the blade member 12 where the chamfered edge 18 is inclined from the bottom surface 14 to the sharp edge 19 in the top surface 13.

In accordance with the present arrangement, a cladding material 20 is applied to the blade member on the surface 14 in a strips or beads parallel to the edge 19 so as to define a side edge 21 of the strip 20 at the edge 19 and a side edge 22 of the strip 20 at a position spaced from the edge 19.

The cladding material 20 is of a greater hardness than the first base material 12.

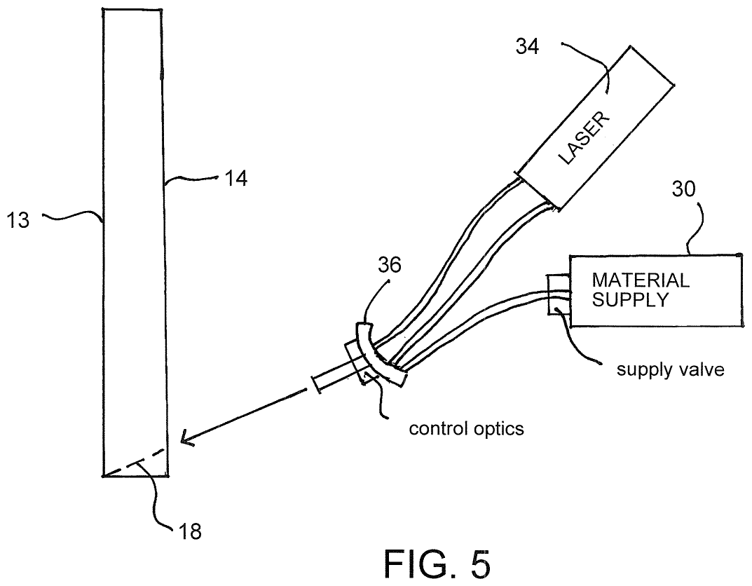

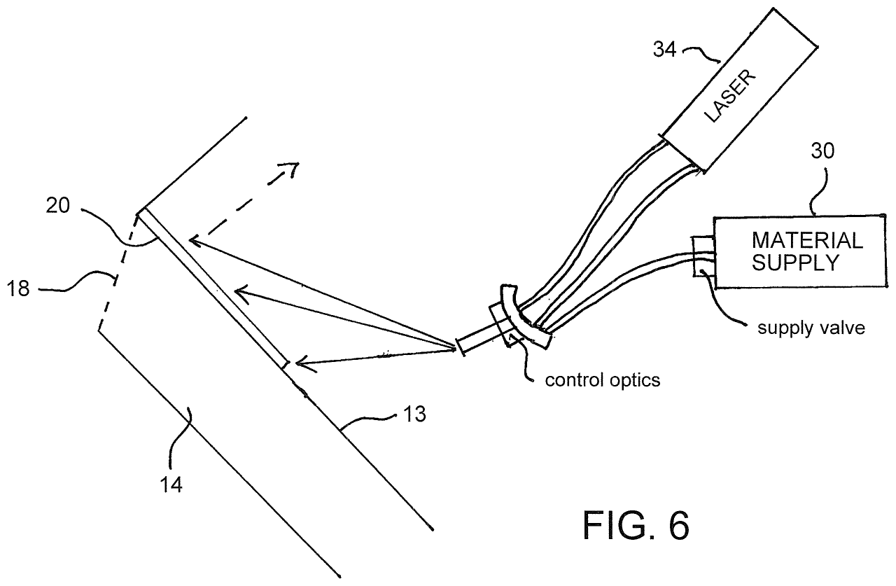

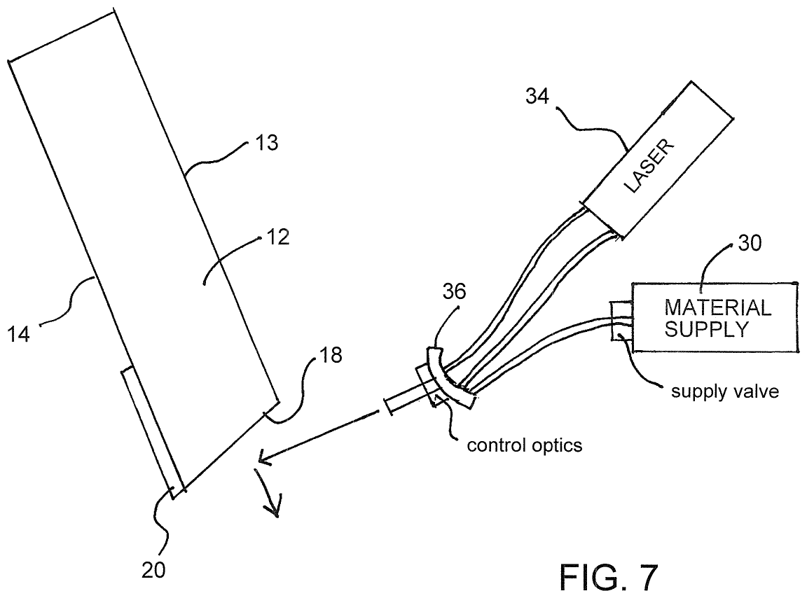

The cladding material is applied as a bead using a CNC control system shown schematically in FIGS. 5 to 9 to accurately lay down and apply the material so that the cladding material 20 is applied accurately as a bead along the blade parallel to the edge 19. The bead is applied along the bottom surface 13 opposite the cutting face 14 at the end 17 and extending partly along the surface 14.

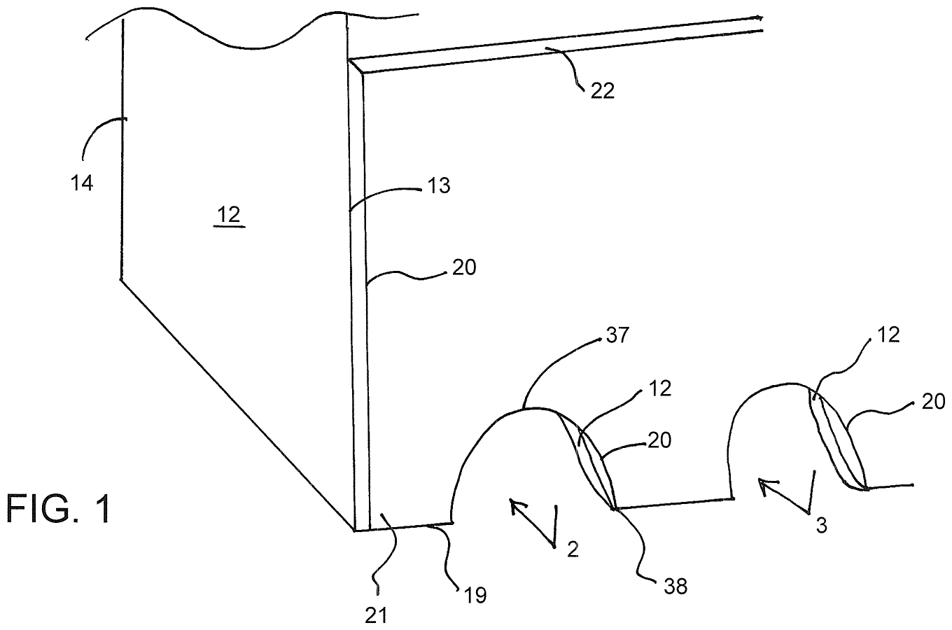

In FIGS. 1 to 4, the chamfered surface 18 is flat and lies at an angle to the flat surface 13 so that the blade edge when initially formed is not serrated. However serrations are formed in the cladding process and continue to form during use as explained hereinafter and as the wear operates to wear back the edge of the base material 12 leaving the edges at the harder material 20 less worn and therefore more pronounced.

The blade has a transverse flat outer edge 17 with the cutting edge 19 extending from the outer edge 17 along one side of the blade 10.

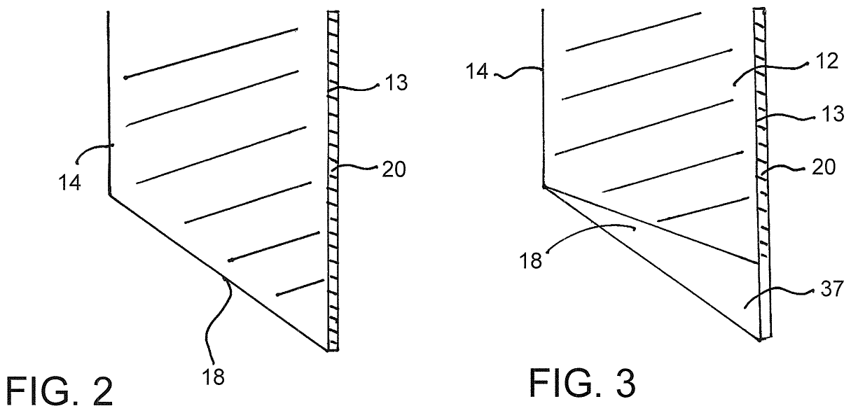

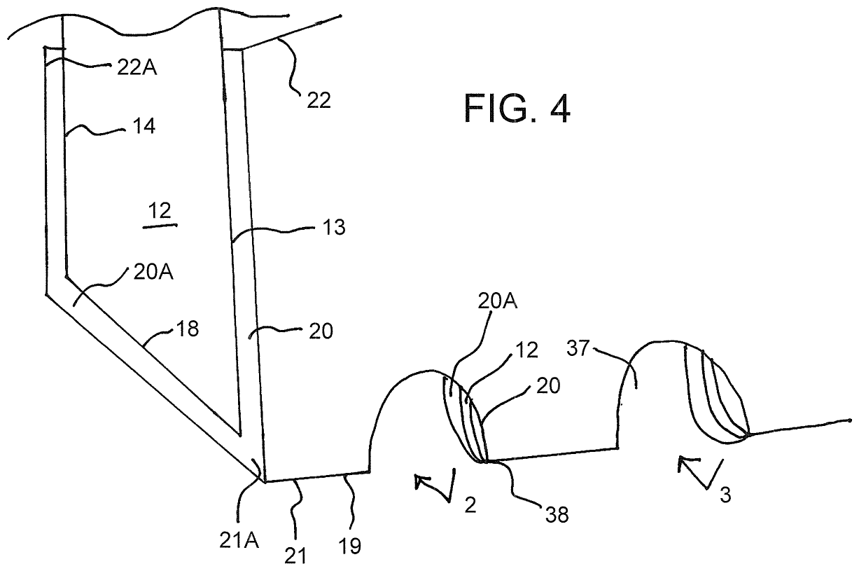

In FIGS. 2 1, 2 and 3, the blade is coated with the cladding material only on the flat face 13 so that the chamfered edge 18 and the rear face 14 are not so coated. However in FIG. 4 an alternative arrangement is shown where there is a strip 20A also applied to the rear face 14 and the face 18 up to the cutting edge 19 so that the strips 20 and 20A meet at the cutting edge 19. Both are applied along the blade parallel to the edge 19. The strip 20A thus defines a side edges 21A at the edge 19 and a side edge 22A spaced from the edge 19 and lying on the face 14.

In FIGS. 9 and 10 is shown one method for forming the blade described where the blade body 10 is mounted in a robotic holder schematically shown at 100 which holds the blade blank in a suitable orientation to cooperate with the cladding system 101. As shown in FIG. 9 this has the flat surface 13 to be clad facing upwardly and the surface 14, having the chamfered edges 18 facing downwardly.

A supply 30 of a cladding material 31, typically in powder form, deposits the strip 20 of the cladding material on to the blade body 10 so as to extend on the blade body in a direction longitudinal to the edge as previously described. The strip 20 is formed independently starting at the end 33 at the surface 17 and moves along the blade toward other end of the blade at the hole 11 where the strip terminates at and end 33A spaced from the other end of the blade. As the material is laid down, the material is heated by a guided laser beam from a controlled laser 34 under control of a CNC control system schematically shown at 35 which also controls the movement of the supply 30. Both the location, the power, and focal point of the laser is controlled so that the required amount of heat is applied to the material at the locations required. The location is controlled relative to the blade blank by the CNC system 35, the power is controlled by a laser control system 34A and the focus is controlled by laser optics system 36.

As shown in FIG. 9, the system lays down the strip 20 by travel along the blade.

As shown in FIG. 10 the energy applied by the laser 34 to the blank is used firstly to cut the bevel or chamfer 18. Subsequently the locations along the strip 20 have heat energy applied so as to burn away a portion of the edge 19 at the strip 20 to form a recessed pocket 37 at the edge.

In a preferred step in the method, an increased power is applied to the laser acts to increase the burn effect at the edge 19 to form the pocket 37. These effects can be controlled and obtained by changing many different control parameters including but not limited to controlling the power supplied to the laser, and/or the focal point of the laser and/or the speed of movement which controls the dwell time at the edge.

Depending on the accuracy of the control, a smaller pocket may be formed at the edge 19 in the strip 20 so that a portion of the edge 19 at the strip 20 which is recessed to form a shallow pocket is smaller than the space between the pockets. This forms a serrated edge as shown with cutting points 38 at the junction between the pocket 37 at the strip 20 and the remaining unburnt or less burnt part of the edge 19 at the strip 20.

This arrangement avoids the complex expensive process for cutting or grinding of the chamfered edge and subsequently forming grooves or serrations so that the chamfered edge itself before cladding is flat. The serrations which assist in the cutting action are thus formed by the burned pockets 37 which are maintained as the blade wears by the difference in hardness at the strip 20 relative to the exposed base material 12 spaces therebetween. The heating action between the strips to burn the edge 19 can be provided by the laser or may be a separate operation after the cladding material in the strip 21 is applied.

The effect obtained is that the thin strip of hard material at the bottom surface continues to form a cutting edge as it and the parent material above it are worn away. As the thin clad material at the edge extends along the full edge leaving no parent material forming the edge, the full length of the edge remains sharp. As the two types of the material of the cladding 20 and the base material 12 wear differently so that the material in the valleys wears more quickly, this material wears away from the edge more quickly to maintain the structure of the valley.

In the field, the blade parent material wears away quickly creating a self-sharpened cutting edge. Because of the laser clad bead, the parent material continues to wear back to the start of the laser clad bead at the end 23. This now self sharpens creating a serrated pocket. As foreign objects hit and chip the edge 19 or coating 20 the blade re-sharpens and continues to cut well.

Areas of the blade that are critical for cutting such as the end corners of the blade at the junction between the edge 19 and the end 17 are coated with the harder laser clad material 20 to ensure blade wear is best controlled in these areas.

This type of blade is desired by a farmer that harvests a lot of crop that is laying down on the ground or has a very abrasive soil environment. The blade when supplied with the pockets 37 already has the serrated edge which cuts best and further wear further increases the serrated shape thus further increasing cutting action. The blade is thus effective and inexpensive to produce in that it does not require convention grinding of the chamfer or the serrated shape.

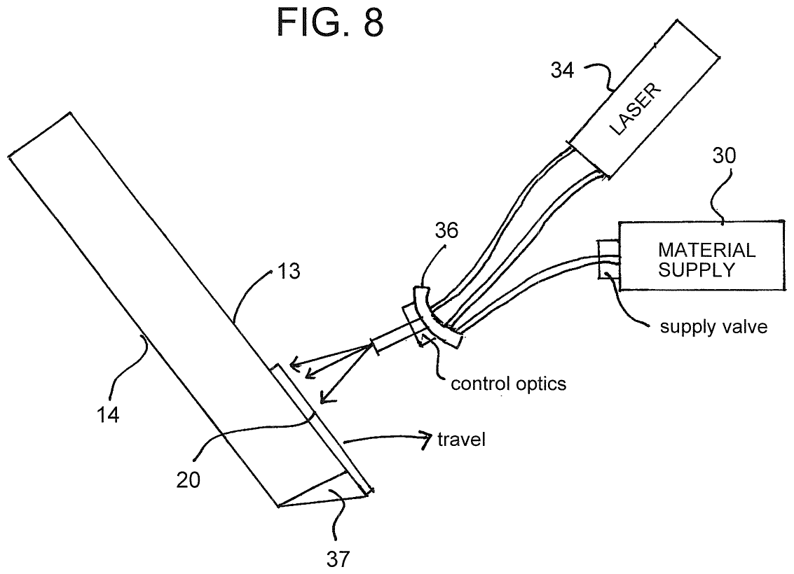

In FIGS. 5, 6 and 7 are shown the individual steps of forming the chamfered edge 18, the coated strip 20, the pockets in that order using the laser tool to cut the blank, coat the strip and remove the material at the pockets. In this arrangement where the pockets are formed after the strip is applied, sufficient heat energy must be supplied to cut through the base material 12 and the cladding 20. In FIG. 8 is shown one step of an alternative order of the steps where the strip 20 is applied after the pockets are cut. In this method the material from the supply 30 simply falls away at the location of the pockets as there is no part of the blade toe support the material at that location.

Thus in this arrangement the strip 20 is applied in a direction longitudinal of the cutting edge 19 so that the strip has a length extending along the cutting edge 19 and a width extending from a first side edge 21 of the strip at the cutting edge and a second side edge 22 spaced from said cutting edge. Heat energy is applied to a position at or adjacent the cutting edge 19 at a plurality of spaced locations along the cutting edge so as to remove away portions of the cutting edge to form a series of recessed pockets 37 along the cutting edge 19 at those locations.

Also in this arrangement, the chamfered surface 18 at the edge of the blade body is cut using heat energy.

Also in this arrangement, two strips 20, 20A are applied with one 20A arranged on the chamfered surface 18 and surface 14 and one arranged 20 on the opposed surface flat surface 13. Heat energy is then applied to the cutting edge 19 at a plurality of spaced locations along the cutting edge 19 so as to remove away portions of the cutting edge 19 including both strips 20, 20A to form a series of recessed pockets 37 along the cutting edge 19 at those locations.

In this arrangement, preferably the blade body is mounted in a laser heating system and the laser heating system is used both to cut the chamfered surface and to apply the cladding material. Also it can be used to cut the series of recessed pockets and to apply the cladding material. Thus using one system a blank metal bar forming the blade body can be cut, coated and serrated in one process using a common laser heating system. However, one or more of the steps may be carried out independently using another heat application system.

Where a common laser system is used, the laser system may provide one work cell with two laser heads with different focal optics. Alternatively, the laser system may comprise one laser head with adjustable optics.

In one arrangement, the strip or strips are applied before the series of recessed pockets are cut so that the heat energy to cut the series of recessed pockets also cuts through the strip.

In another arrangement, the strip or strips are applied after the series of recessed pockets are cut so that the cladding material, typically a powder is discarded at the series of recessed pockets as there is no material at those locations on to which the material is applied.

The strip can comprise a single strip applied to one surface and typically to the flat surface opposite the chamfered surface, which forms a planar side of the blade body. Alternatively, two strips can be applied with one arranged on the chamfered surface and one arranged on the opposed surface. These strips thus meet at the edge and provide a highly wear resistant or hardened edge. However, the hardened edge can still be cut away at the required locations to form the serrations. The chamfered surface is flat.

1. A method for forming a blade for mounting on a rotor of a cutting machine for cutting vegetation comprising:
forming a chamfered surface on a blade body to define a cutting edge of the blade body;
the blade body being formed of a base material;
applying at least one strip of cladding material to the blade body at the cutting edge so as to provide at least one part of the cutting edge which has the cladding material thereon;
the cladding material having a resistance to wear greater than that of the base material;
said at least one strip being applied in a direction longitudinal of the cutting edge so that said at least one strip has a length extending along the cutting edge and a width extending from a first side edge of said at least one strip at the cutting edge and a second side edge spaced from said cutting edge;
and applying heat energy to the cutting edge at a plurality of spaced locations along the cutting edge so as to remove away portions of the cutting edge to form a series of recessed pockets along the cutting edge at the locations.

2. The method according to claim 1 wherein the blade body is mounted in a laser heating system and the laser heating system is used both to cut the series of recessed pockets and to apply the cladding material.

3. The method according to claim 2 wherein the laser heating system used both to cut the recessed pockets and to apply the cladding material uses the same laser.

4. The method according to claim 3 wherein the laser comprises one work cell with two laser heads with different focal optics.

5. The method according to claim 3 wherein the laser comprises one laser head with adjustable optics.

6. The method according to claim 1 wherein said at least one strip is applied before the series of recessed pockets are cut so that the heat energy to cut the series of recessed pockets also cuts through said at least one strip.

7. The method according to claim 1 wherein said at least one strip is applied after the series of recessed pockets are cut so that the cladding material is discarded at the series of recessed pockets.

8. The method according to claim 1 wherein said at least one strip comprises two strips with one arranged on the chamfered surface and one arranged on an opposed surface.

9. The method according to claim 8 wherein the opposed surface forms a planar side of the blade body.

10. The method according to claim 1 wherein the chamfered surface is flat.

11. A method for forming a blade for mounting on a rotor of a cutting machine for cutting vegetation comprising:
forming a chamfered surface on a blade body to define a cutting edge of the blade body;
the blade body being formed of a base material;
applying at least one strip of cladding material to the blade body at the cutting edge so as to provide at least one part of the cutting edge which has the cladding material thereon;
the cladding material having a resistance to wear greater than that of the base material;
wherein said at least one strip comprises two strips with one arranged on the chamfered surface and one arranged on an opposed surface; and
applying heat energy to the cutting edge at a plurality of spaced locations along the cutting edge so as to remove away portions of the cutting edge to form a series of recessed pockets along the cutting edge at the locations.

12. The method according to claim 11 wherein the blade body is mounted in a laser heating system and the laser heating system is used both to cut the series of recessed pockets and to apply the cladding material.

13. The method according to claim 11 wherein the laser heating system used both to cut the series of recessed pockets and to apply the cladding material uses the same laser.

14. The method according to claim 13 wherein the laser comprises one work cell with two laser heads with different focal optics.

15. The method according to claim 13 wherein the laser comprises one laser head with adjustable optics.

16. The method according to claim 11 wherein said at least one strip is applied before the series of recessed pockets are cut so that the heat energy to cut the series of recessed pockets also cuts through said at least one strip.

17. The method according to claim 11 wherein said at least one strip is applied after the series of recessed pockets are cut so that the cladding material is discarded at the series of recessed pockets.

18. The method according to claim 11 wherein the opposed surface forms a planar side of the blade body.

19. The method according to claim 11 wherein the chamfered surface is flat.

20. The method according to claim 11 wherein said two strips are applied in a direction longitudinal of the cutting edge so that each strip has a length extending along the cutting edge and a width extending from a first side edge of the strip at the cutting edge and a second side edge spaced from said cutting edge.
